(19) United States
(12) Patent Application Publication
(10) Pub. No.: US 2013/0264366 A1
(43) Pub. Date: Oct. 10, 2013

(54) CLAMPING MECHANISM

(71) Applicants: Peter Douglas Hubbard, Christchurch (NZ); Bruce John Robertson, Christchurch (NZ)

(72) Inventors: Peter Douglas Hubbard, Christchurch (NZ); Bruce John Robertson, Christchurch (NZ)

(73) Assignee: HUBCO AUTOMOTIVE LIMITED, Wellington (NZ)

(21) Appl. No.: 13/696,988

(22) PCT Filed: May 17, 2011
(86) PCT No.: PCT/NZ11/00078

§ 371 Date: Jun. 6, 2013

(30) Foreign Application Priority Data
May 17, 2010 (NZ) 583777

(51) Int. Cl. B60R 9/055

(52) U.S. Cl. CPC B60R 9/055
USPC 224/328

(57) ABSTRACT

A roof box 1 for mounting to a vehicle is described. The roof box 1 includes a clamping mechanism that enables the roof box 1 to be secured to a vehicle via one or more externally accessed actuating handles 5. A crossbar interchangeable clamp shape is also described for linking an accessory item such as a roof box 1 to a roof rack cross bar.

### TECHNICAL FIELD

The invention relates to a clamping mechanism. More specifically, the invention relates to a clamping mechanism used to mount a vehicle roof box to vehicle roof rack crossbars.

### BACKGROUND ART

Roof boxes are well known and commercialised worldwide. Roof boxes comprise a container mountable to a roof area of a vehicle and are adapted to store luggage, cargo and/or other objects (e.g. sporting equipment such as skis and snowboards). Typically, the roof box is made up of a bottom section for mounting to the roof area of a vehicle and a top section movable relative to the bottom section for opening and closing the roof box. Roof boxes may be preferable to an open roof rack accessory holder since they protect the items stored inside from exposure to adverse weather and environmental conditions as well as provide robust protection against theft and vandalism.

There are a wide range of different styles, features and prices available although roof boxes have become very standardised in design. In particular, typical design features common to many designs include central locking, double sided opening, quick fit attachment from inside the roof box, the ability to fit a range of roof racks and various styling shapes.

One drawback noted above of roof box designs is that the roof box clamping mechanism is achieved via one or more mechanisms that can only be reached via the interior of the roof box. Examples of this style of mechanism include U.S. Pat. No. 6,918,521 and U.S. Pat. No. 7,637,405 where the clamping assembly is actuated by turning a knob accessible only by opening the roof box and reaching inside the roof box. Drawbacks include having to remove the roof box contents in order to access the clamping mechanism and remove the roof box form the roof racks. Secondly, the clamping mechanism when mounted on a vehicle can be difficult to reach, particularly if the vehicle has a relatively high ground clearance. Ideally it would be useful to have a roof box with a clamping mechanism that could be releasably fitted to a vehicle roof rack via an externally accessed clamping mechanism.

It is an object of the present invention to address the foregoing problems or at least to provide the public with a useful choice.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description that is given by way of example only.

### SUMMARY OF THE INVENTION

The invention broadly relates to a roof box with a clamping mechanism that allows the user to releasably clamp the roof box to a roof rack assembly without having to access the interior of the roof box.

In a first embodiment there is provided a roof box including a base section mountable to at least one roof rack and a top section movable relative to the base section for opening and closing the roof box wherein the roof box has a clamping mechanism for clamping the roof box to a roof rack including:
a. at least one torque input device;
b. at least one clamp;
c. at least one force transfer means linking the torque input device(s) to the clamp(s); and
d. at least one load equalising device.

In a second embodiment there is provided a method of securing a roof box to at least one roof rack by use of a clamping mechanism that engages a roof rack crossbar on a vehicle including: at least one torque input device; at least one clamp; at least one force transfer means linking the torque input device(s) to the clamp(s); and at least one load equalising device; and wherein a user secures the roof box by the step of:
(a) the user actuates the torque input device or devices on the roof box exterior thereby causing the force transfer means to tighten the clamp or clamps against one or more roof rack crossbars and the tightness of the clamp or clamps is governed by the load equalising device or devices.

In a third embodiment there is provided a clamp for linking a roof rack accessory item to a roof rack cross bar wherein the clamp can be used on a variety of crossbar shapes wherein the clamp comprises:
(a) a fixed portion integral to the accessory item; and
(b) an opposing pivoting claw;
   wherein the cross sectional profile of the fixed portion and claw when in a crossbar holding position abuts the crossbar about three surfaces of contact, producing three resolved applied forces on the crossbar to constrain the crossbar within the clamp.

Advantages of the roof box provided by the clamping mechanism include ease of access, particularly as the clamping mechanism may be reached without needing to access the inside of the roof box. Further, the clamping mechanism may optionally be fitted to the roof racks via one actuating handle thereby reducing the time and effort required to remove the box. Further, clamping and unclamping may be achieved from either side of the roof box making access easy, particularly when the box is mounted on a raised vehicle roof.

Finally, the roof box is useful in that it protects the items stored inside from exposure to adverse weather and environmental conditions as well as provides robust protection against theft and vandalism.

### BRIEF DESCRIPTION OF THE DRAWINGS

Further aspects of the present invention will become apparent from the following description that is given by way of example only and with reference to the accompanying drawings in which:

FIG. 1 illustrates an assembled perspective view from above of one embodiment of the roof box of the invention;

FIG. 2 illustrates a perspective view of the assembled roof box viewed from below;

FIG. 3 illustrates a perspective view of the assembled roof box viewed from below linked to a roof rack;

FIG. 4 illustrates a perspective view of the roof box base section viewed from above;

FIG. 5 illustrates a perspective view of the roof box base section as shown in FIG. 4 with the inner skin of the base section removed to expose the clamping mechanism;

FIG. 6 illustrates a perspective detail view of the clamping mechanism from underneath the roof box with the top and base sections removed to expose the clamping mechanism;

FIG. 7 illustrates a detail perspective view of the clutch assembly;

FIG. 8 illustrates a perspective detail view of the clamp assembly including the clutch assembly;

FIG. 9 illustrates a detail side view of the clamp assembly with the clamp jaw in an open position;

FIG. 10 illustrates a detail side view of the clamp assembly with the clamp jaw in an open position around a roof rack;

FIG. 11 illustrates a detail side view of the clamp assembly with the clamp jaw in a closed position;

FIG. 12A to 12D illustrates a detail side view of the clamp assembly with the clamp jaw in a closed position around four different existing roof racks currently on the market;

FIG. 13 illustrates a detail side elevation view of an alternative clamp assembly;

FIG. 14 illustrates an exploded perspective view of the alternative clamp assembly of FIG. 13;

FIG. 15 illustrates a cross-section view taken about the lateral channel of the assembled roof box and clamping mechanism;

FIG. 16 illustrates a detail perspective view of the lock assembly and locking plunger;

FIG. 17 illustrates a detail side elevation view of the handle and right angle gearbox;

FIG. 18 illustrates a detail side elevation view of the handle and lock assembly when the handle is in a locked and retracted position;

FIG. 19 illustrates a detail side elevation view of the handle and lock assembly when the handle is in an unlocked and extracted position;

FIG. 20 illustrates a perspective view of the rear of the assembled roof box showing an alternative clamping mechanism embodiment; and

FIG. 21 illustrates a side elevation view of the alternative embodiment of FIG. 20 along with details of the clamping mechanism.

### DETAILED DESCRIPTION

As noted above, the invention broadly relates to a roof box with a clamping mechanism that allows the user to releasably clamp the roof box to roof racks without having to access the interior of the roof box.

In a first embodiment there is provided a roof box including a base section mountable to at least one roof rack and a top section movable relative to the base section for opening and closing the roof box wherein the roof box has a clamping mechanism for clamping the roof box to a roof rack including:
a. at least one torque input device;
b. at least one clamp;
c. at least one force transfer means linking the torque input device(s) to the clamp(s); and
d. at least one load equalising device.

For further clarification, the term ‘roof rack’ refers to a linkage assembly between the roof box and a vehicle roof. In one embodiment, the roof box may clamp to the roof rack via cross bars.

The torque input device may be a handle or motor.

The force transfer means may be a drive shaft, chain or belt.

The load equalising device may be a clutch or differential.

The torque input device or devices may be mounted along the longitudinal side of the roof box and communicate with the clamp or clamps via a force transfer means being a cross driveshaft linked to a right angle gearbox and a longitudinal driveshaft on which the clamp or clamps are mounted. The right angle gearbox transfers rotation of the cross driveshaft to rotation of one or more longitudinal driveshafts wherein the cross driveshaft and longitudinal driveshaft(s) are mounted at an approximate 90 degree angle to each other.

The roof box may roof box may have two torque input devices located on each longitudinal side of the roof box allowing actuation of the clamping mechanism from either side of the roof box. In this embodiment, the two torque input devices are linked to two separate force transfer means being cross driveshafts that are linked via a transfer gearbox. In this embodiment, the transfer gearbox communicates actuation of at least one torque input device to the clamp or clamps so that the clamping mechanism is operated via one torque input device. Avoiding actuation of the opposing handle in the above embodiment may be achieved by use of a mechanism in the opposing handle that disengages the driveshaft when not in use and engages the driveshaft when in use. This mechanism allows the clamping mechanism to be operated via one extended actuating handle while the opposing handle remains locked away.

In an alternative embodiment, the roof box may include one or more torque input devices located at the rear of the roof box which are used to actuate the clamp or clamps. In this embodiment, each torque input device may actuate only a single longitudinal shaft or alternatively, may actuate more than one shaft via a communicating means between the first torque input device and other shafts if used.

In the above embodiment, the torque input device or devices are a handle or handles that are actuated by rotation of the handle or handles.

Optionally, the torque input device or devices may be nested within at least one housing receptacle on the roof box base section. In this embodiment, the torque input device or devices are may be nested into the base section of the roof box so that the torque input device does not protrude from the roof box base section, thereby minimising wind drag and maintaining the aesthetics of a smooth roof box exterior.

The torque input device or devices may be moved from a neutral or non-engaged position for storage to an engaged or actuating position by movement in the horizontal plane. Optionally, the torque input device may be a handle that may include a square section that when mated to a driveshaft, engages the handle to the driveshaft. In one embodiment, the user engages the torque input device or devices by pulling the device away from the roof box side wall or walls which not only makes the handle easier to access and turn, but also engages the handle to the driveshaft.

In one embodiment, the torque input device or devices may be locked when not in use via a locking assembly. The locking assembly may include a locking plunger biased to engage a cam surface on the handle and, unless unlocked, the biased plunger prevents the handle from being pulled away from the roof box and actuated.

In one embodiment, the clamp or clamps include a clamp jaw, a clamp body and a jaw movement assembly that transfers torque input device actuation to clamp jaw movement relative to the clamp body. In this embodiment, the clamp jaw pivots about an axis linking one end of the clamp jaw and the clamp body. In one embodiment, the jaw movement assembly includes a clamp slider driven along the driveshaft axis and which communicates rotational movement of the clamp jaw via at least one pivotal link. In an alternative embodiment, the jaw movement assembly includes a worm driven along the driveshaft axis and which communicates rotational movement of the clamp jaw via a ratchet arrangement on the clamp jaw that engages the worm.

In one embodiment, the load equalising device or devices torque limit the torque input device or devices. The load equalising device is a clutch assembly that includes a drive spindle and a drive spline that drive a driven spline and wherein, when maximal torque is reached by rotation of the drive spindle and drive spline, the driven spline is forced to disengage from the drive spline via angled facings on the drive spline and wherein, when direction of rotation is reversed, the driven spline reengages the drive spline. When the direction of rotation of the driveshaft is reversed in order to unclamp the clamping assembly, the driven spline re-engages the drive spline via a bias means.

Optionally, the clamping mechanism may be housed within the base section of the roof box and the only externally viewed features of the clamping mechanism beyond the roof box exterior is the clamp or clamps and the handle or handles. If present, a lock assembly may be used that is also visible on the beyond the roof box exterior. The base section of the roof box may include at least one channel that houses the clamping mechanism. It should be appreciated that by minimising the visual impact of the clamping mechanism, the aesthetics of the roof box are maintained including keeping an aerodynamic and smooth external profile.

Each clamp of the clamp assembly as described above may also be moved in the longitudinal direction of the roof box. Where a channel is used to house the clamp body, the clamp body may be moved back and forth along the channel enclosure and fixedly engaged in a desired position. As may be appreciated, this movement is useful to allow for variations in roof rack spacing thereby allowing the roof box clamping mechanism to be used on almost any roof rack spacing.

In a second embodiment there is provided a method of securing a roof box to at least one roof rack by use of a clamping mechanism that engages a roof rack crossbar on a vehicle including: at least one torque input device; at least one clamp; at least one force transfer means linking the torque input device(s) to the clamp(s); and at least one load equalising device; and wherein a user secures the roof box by the step of:
(a) the user actuates the torque input device or devices on the roof box exterior thereby causing the force transfer means to tighten the clamp or clamps against one or more roof rack crossbars and the tightness of the clamp or clamps is governed by the load equalising device or devices.

The above method may include variations in the clamping mechanism substantially as hereinbefore described.

In a third embodiment there is provided a clamp for linking a roof rack accessory item to a roof rack cross bar wherein the clamp can be used on a variety of crossbar shapes wherein the clamp comprises:
(a) a fixed portion integral to the accessory item; and
(b) an opposing pivoting claw with a double concave crossbar facing surface;
   wherein the cross sectional profile of the fixed portion and claw when in a crossbar holding position abuts and releasably retains the accessory item against the crossbar, producing three resolved applied forces on the crossbar to constrain the crossbar within the clamp.

The fixed portion of the clamp may have a cross sectional shape comprising a notch between two raised projections wherein the transition between the notch and one or both of the raised projections may be a smoothed arcuate angle. The forward facing transition between the projection and notch as fitted to a vehicle may be a smoothed path suitable to receive a tear drop cross section shaped crossbar. The flat-sided raised projection of the clamp body at the pivot side abuts the surface of the crossbar parallel and closest to the rear of the vehicle. In a crash situation, the flat-sided raised projection will constrain the crossbar by applying a reaction force to the contact surface of the crossbar opposing the direction of acceleration of the crossbar. This enables the clamp to meet or exceed various safety criteria as well as cater for a variety of rack shapes unlike art clamps that may not meet safety requirements or not cater for various crossbar types.

The claw interior shape may have a concave cross sectional shape relative to the crossbar designed to nest the crossbar therein. The concave shape may further be divided into two concave regions termed a ‘double concave shape’. The second concave region of the double concave shape of the claw may be located towards the non-pivot point distil end of the claw.

The above clamp has the advantage of being able to be attached to a wide variety of roof rack crossbar shapes unlike many clamps in the art that may only be attached to proprietary crossbar shapes. As should be appreciated, the ability to attached an accessory item to many different racks means that the purchaser of the accessory item does not also have to purchase corresponding roof rack crossbars but instead can fit the accessory item to a wide variety of existing crossbars on the market.

The above clamp may include variations in the clamping mechanism substantially as hereinbefore described.

The above described roof box clamping mechanism is now described by reference to a working example illustrating one embodiment and variations thereof.

### WORKING EXAMPLES

The invention is now described with reference to a detailed description of various embodiments of the roof box of the present invention.

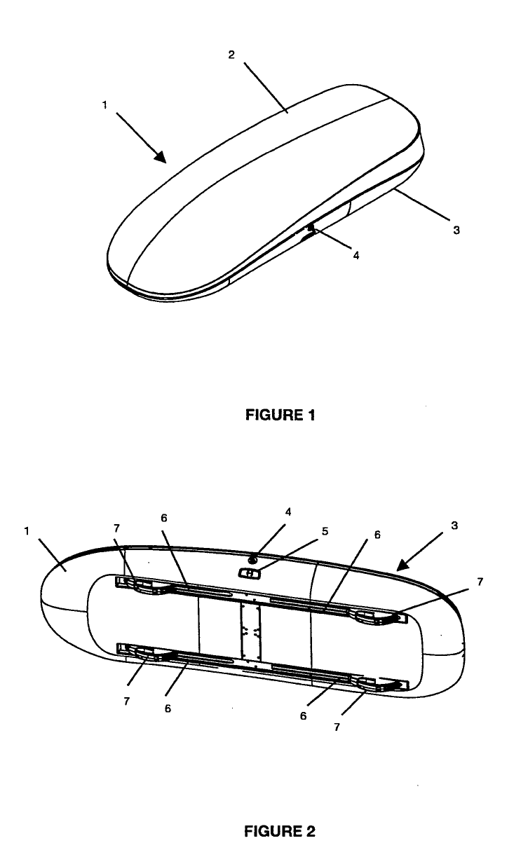

Referring to FIG. 1, the roof box, generally indicated by arrow 1, when closed has a styled, aesthetically appealing shape. The roof box 1 includes a top section 2 and a base section 3. The roof box 1 includes a lock assembly 4. No features of the clamping assembly are visible from the exterior of the roof box 1 when viewed from above as in FIG. 1.

FIG. 2 illustrates the roof box 1 in assembled mode when viewed from below. The box 1 still includes the top section 2 and base section 3. The lock assembly 4 is also still visible. Newly viewed in FIG. 2 is the clamping assembly handle 5 used to urge clamping and removal of the roof box from the vehicle roof racks (not shown). The underside of the roof box 1 base section 3 includes four slots 6 positioned to approximate the roof rack position on a vehicle roof. It should be appreciated that the slots 6 extend beyond the width required for the clamp assembly 7 itself to ensure that the clamp assemblies 7 can be moved forwards or backwards within the confines of the slots 6 to fit the varied roof rack spread on vehicle roofs. The clamp assemblies 7 are the only prominent feature of the clamp mechanism viewable form the exterior of the roof box when assembled.

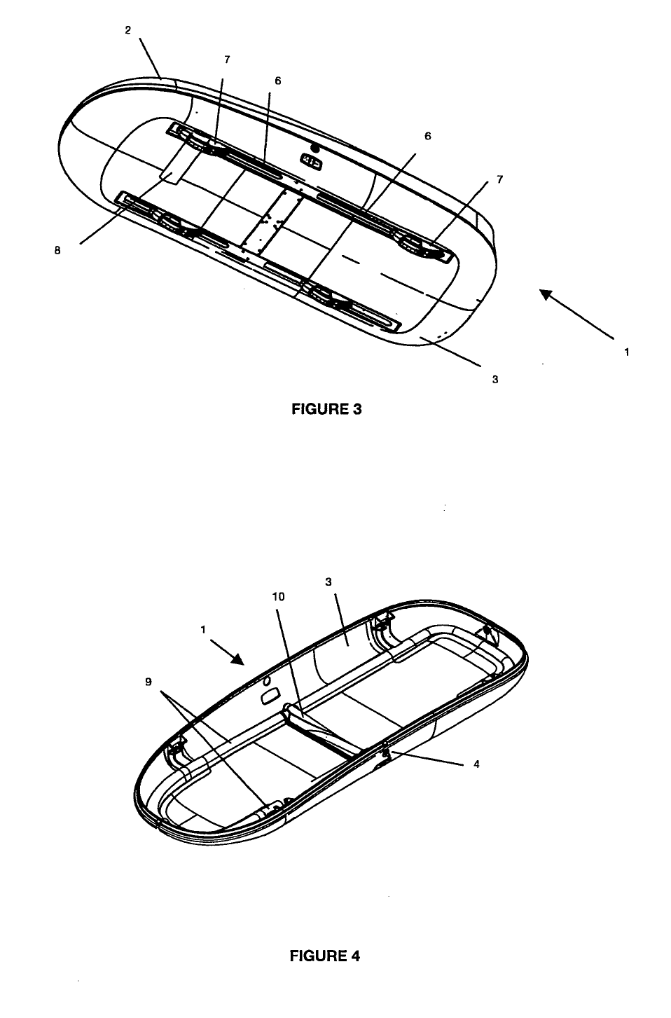

FIG. 3 further illustrates the assembled roof box 1 and clamping mechanism when attached to a roof rack 8 (partial assembly shown), in this case an aerodynamic low noise rack. Differing styles of clamp assembly 7 are illustrated illustrating how the clamp design may be altered without departing from the scope of the invention. Note that FIG. 3 is drawn with four clamp assemblies 7 visible.

FIG. 4 illustrates the roof box 1 base section 3 interior with the top section 2 removed. The base section 3 moulding houses the clamping mechanism within two longitudinal channels 9 extending along the sides of the roof box 1 base section 3 when mounted on a vehicle and one lateral channel 10 extending along the width of the roof box 1 base section 3 approximately in line with the lock assembly 4.

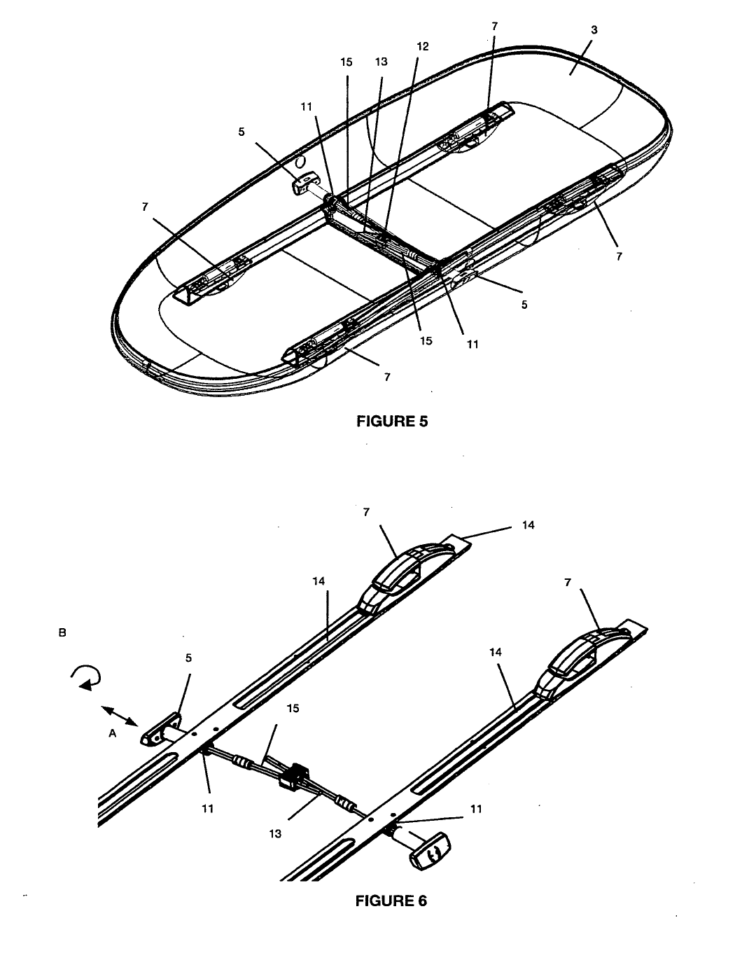

FIG. 5 shows the same view as that of FIG. 4 but with the internal skin of the base section 3 removed to expose the clamping mechanism. In this embodiment, the base section 3 has a double skin fused together at the seam of the base section 3. This should not be seen as limiting as a non-double skinned embodiment may also be possible where the clamping mechanism is hidden via panels within the base section 3 of the roof box 1.

FIG. 6 shows a detail view of the clamping mechanism from underneath the roof box 1 with the top 2 and base 3 sections of the roof box 1 removed.

As shown in FIGS. 5 and 6, the clamping mechanism includes a lock assembly 4 (not shown) and an actuating handle 5. The lock assembly 4 retains the actuating handle 5 flush with the roof box 1 exterior and prevents rotation of the handle 5 until unlocked. Turning the key (not shown) releases the handle 5 allowing the user to pull the handle 5 away from the roof box 1 body 2,3 in direction A and rotate the handle 5 in direction B to cause clamping or unclamping of the clamp assemblies 7. The handle 5 is linked to a cross driveshaft 15 that enters a transfer gearbox 12. When the handle 5 is pulled in direction A, the transfer gearbox 12 and right angle gearboxes 11 are engaged. Bias means (not shown) on the handle 5 will not only bias the handle 5 forwards out of the roof box 1 housing when unlocked, but also partly or fully engage the cross driveshaft 15 to the respective gearboxes 11, 12. A stop 13 in the form of a flange or collar and/or split pin is included at the end of the cross driveshaft 15 to prevent the handle 5 from inadvertently being pulled out too far in direction 1. Transfer of rotational torque from the handle 5 to all four clamp assemblies 7 occurs via two right angle gearboxes 11 and a transfer gearbox 12. The right angle gearboxes 11 transfer rotational torque in the cross driveshaft 15 to rotation of the longitudinal driveshaft 14. The transfer gearbox 12 reverses the direction of rotation so that all four clamp assemblies 7 operate in unison. The clamping mechanism includes a clutch assembly 16 inside the clamp assembly 7. In addition, items mounted on the longitudinal driveshaft 14 are housed within a flanged channel 20.

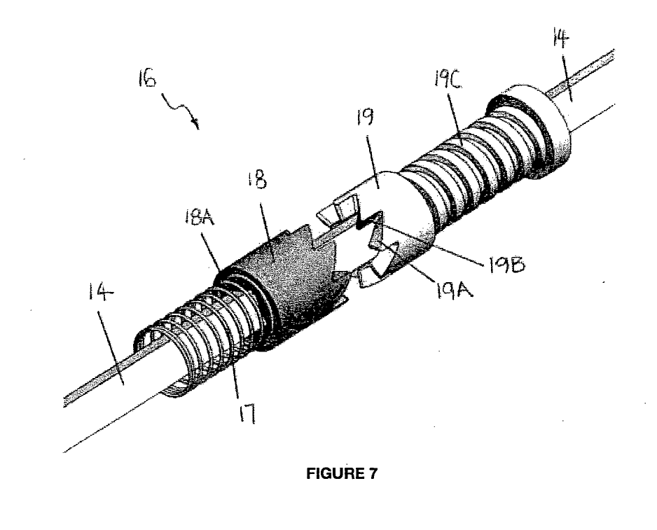

FIG. 7 shows detail views of the clutch assembly 16 used to limit the tension placed on the roof racks 8 and avoiding damage to the racks 8 and clamp assembly 7 yet still retain sufficient grip between the racks 8 and roof box 1. The clutch assembly 16 includes a driven spline 18 mating with a driving spline 19. The driven spline 18 is biased against the driving spline 19 via a bias means such as a spring 17. Each clutch assembly 16 is mounted on to the longitudinal driveshaft 14 within the clamp assembly 7. When the longitudinal driveshaft 14 is rotated to tighten the clamp(s), the driving spline 19 rotates the driven spline 18 that in turn closes the clamp jaw 21 of the clamping assembly 7. When a maximal amount of torque is reached (torque limit) corresponding to when the clamp jaw 21 is tightened against the roof rack(s) 8 the driven spline 18 will be urged out of the driving spline 19 against the bias means 17 via the angled facings 19A on the driving spline 19 and an audible ‘clicking’ noise may be heard as the driven spline 18 disengages the driving spline 19. When the handle 5 is rotated in the opposite direction corresponding to when the clamp jaw(s) 21 are loosened from the rack(s) 8, the upright facings 19B on the driving spline 19 are engaged by the driven spline 18. In the embodiment shown in FIG. 7, the driving spline 19 includes worm section 19C that engages with the clamp jaw 21.

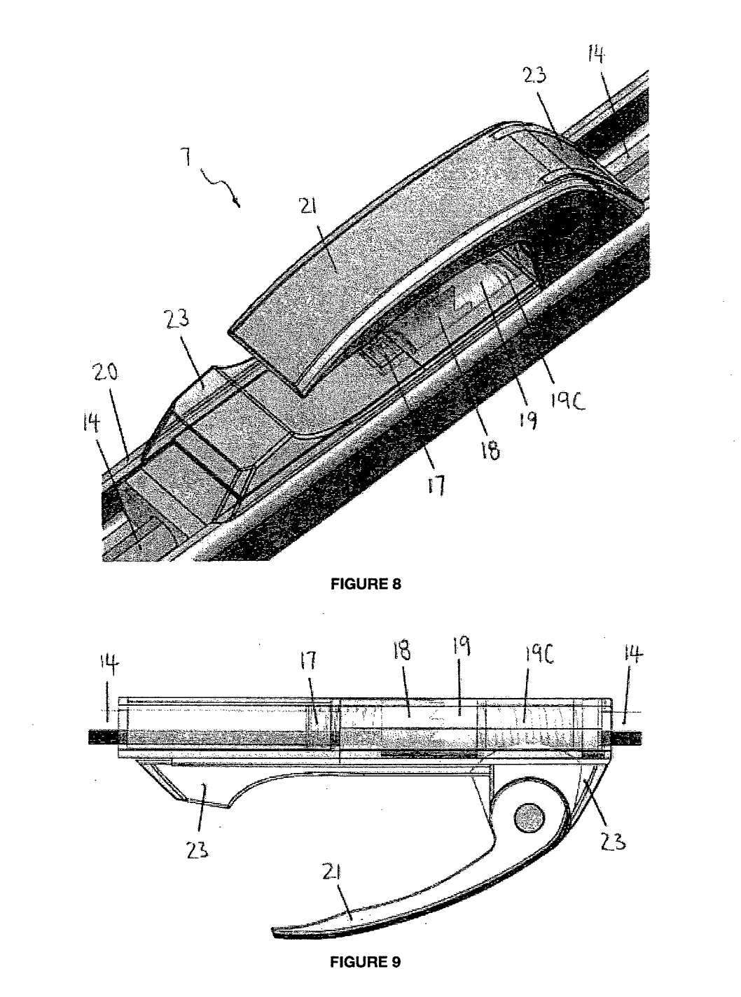

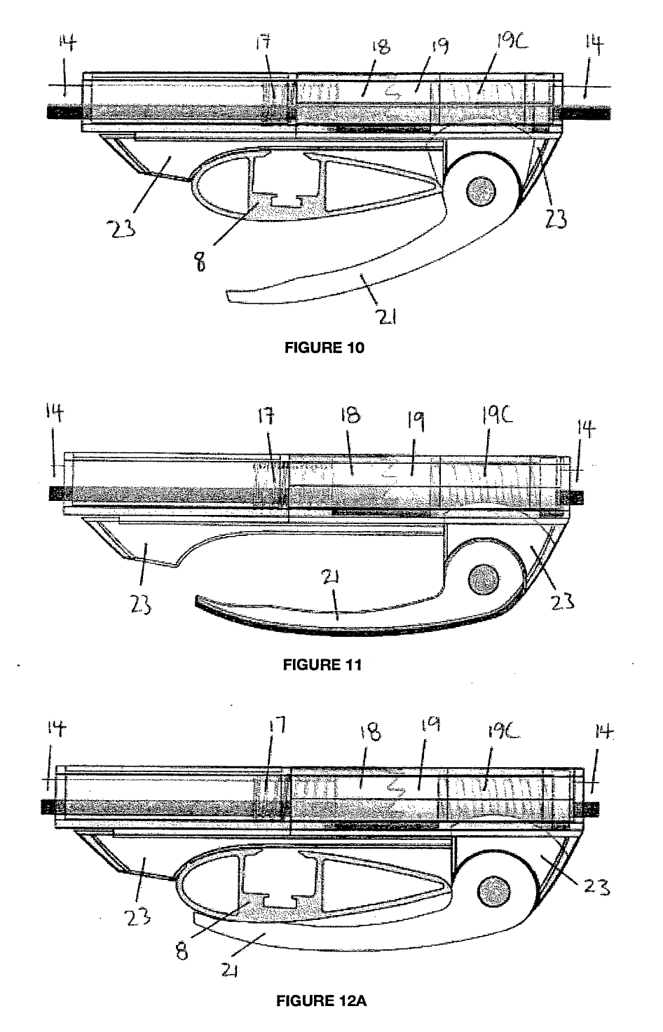

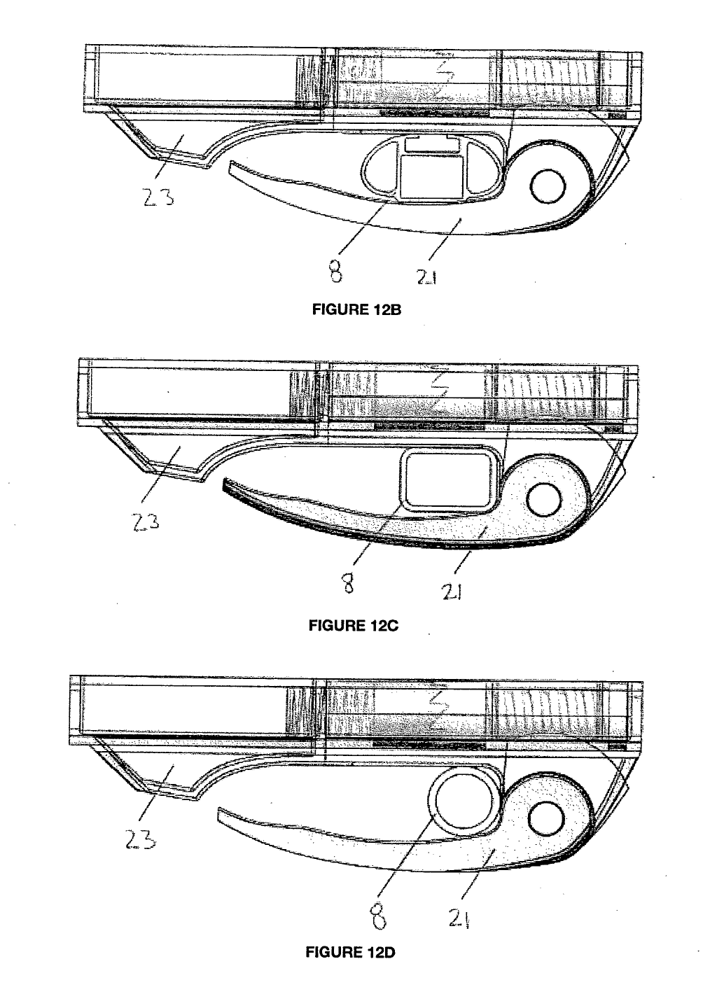

FIGS. 8 to 12 show detail views of the clamping assembly 7. FIG. 8 illustrates a perspective view of the assembled clamping assembly. FIGS. 9 and 10 show the clamping assembly 7 in an open position with and without a roof rack 8. FIGS. 11 and 12A to 12D show the same clamping assembly 7 in a closed position, again with and without a roof rack 8. In all of these Figures, the clamp body 23 is made transparent to show the inner parts of the assembly 7.

The clamping assembly 7 includes a clamping jaw (also referred to in this specification as a claw or clamp arm) 21 that pivots about an axis to open and close the jaw 21. The clamping jaw 21 is linked a fixed portion or clamp body 23. The clamp body 23 is housed within a flanged channel 20. The flanged channel 20 extends along the longitudinal channel 9 of the roof box 1 base section 3 and contains the clamping mechanism componentry including the longitudinal driveshaft 14. Also shown in FIG. 8 is the clutch assembly 16 nested within the clamp body 23.

Referring specifically to FIGS. 12A to 12D, the clamping assembly 7, is shown attached to four different commonly marketed crossbar types and illustrates how the clamp shape may be used to attached a roof box or any other accessory item securely to a crossbar. Particular aspects of the shape described by the combination of the clamp body 23 and jaw 21 when closed include the arcuate transition at the leading edge of the clamp body 23A, the double concave shape 21A of the jaw 21 interior and the flat-sided raised projection of the clamp body at the pivot side.

Due to the resolved clamping force A applied to the crossbar 8 and the clamp shape 21A, resolved reaction forces B and C act on the crossbar 8. In a crash situation, movement of crossbar 8 in direction of acceleration D will be prevented in particular but not exclusively by the reaction force C applied by the flat-sided raised projection of the clamp body 23 at the pivot side.

In use, as the handle 5 is rotated to clamp the roof rack 8, the clutch assembly 16 is rotated via rotation of the longitudinal driveshaft 14. The worm 19C on the driving spline 19 mates with a ratchet assembly on the clamping jaw 21 and, when the worm is rotated, the clamping jaw(s) 21 are closed or opened.

As illustrated by FIGS. 12A to 12D, the clamping mechanism may be used for a variety of different cross section roof racks and the roof rack shape/cross bar shape is not limiting in terms of the clamping mechanism design.

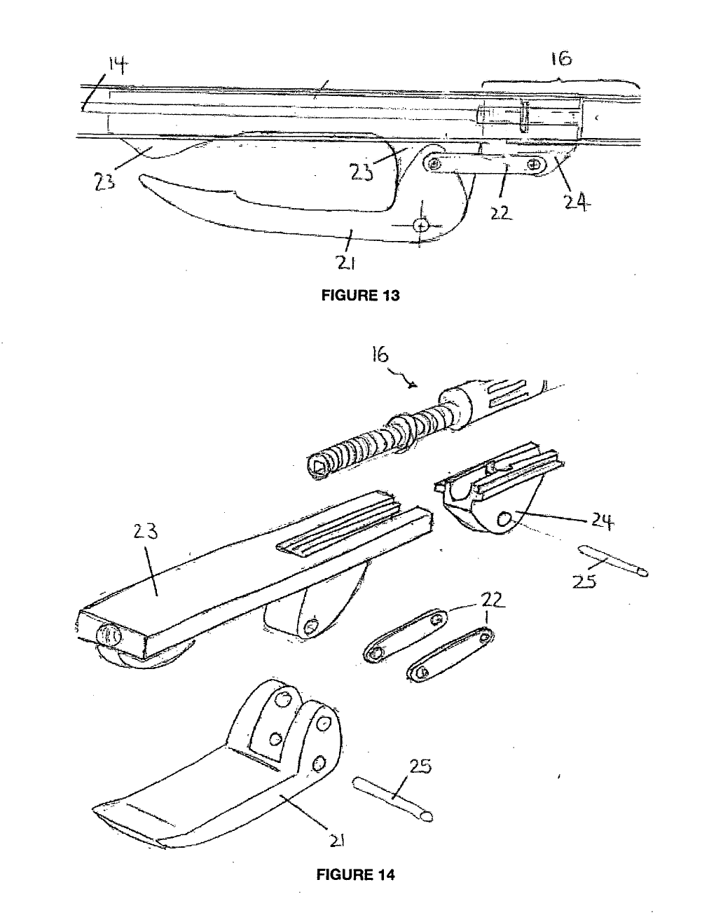

In an alternative embodiment shown in FIGS. 13 and 14, the clamp body 23 and clamping jaw 21 are linked to a clamp slider 24 via a link 22. The parts of the clamp assembly 7 are retained together using a mechanical fastener such as link pins 25. In use, as the handle 5 is rotated to clamp the roof rack 8, the clutch assembly 16 engages the driveshaft 14 pulling the clamp slider 24 away from the clamp assembly 7 thereby urging the clamping jaw 21 towards the clamp body 23 and fastening the clamp jaw 21 and clamp body 23 around a roof rack 8. When the handle 5 is rotated in the opposite direction to unclamp the clamp assemblies 7, the clutch assembly 16 engages and drives the clamp slider 24 towards the clamp body 23 thereby opening the clamp jaw 21.

FIG. 14 shows a further representation of the clamp assembly 7 in an exploded view to further illustrate the different parts of the assembly 7 in the alternative embodiment. In this exploded view, the channel 20 has been removed for clarity although it can be seen how the clamp body 23 is sized to fit and be retained within the flanged channel 20. The clamp slider 24 is shown in more detail including how the clamp slider 24 nests the clutch spindle 17.

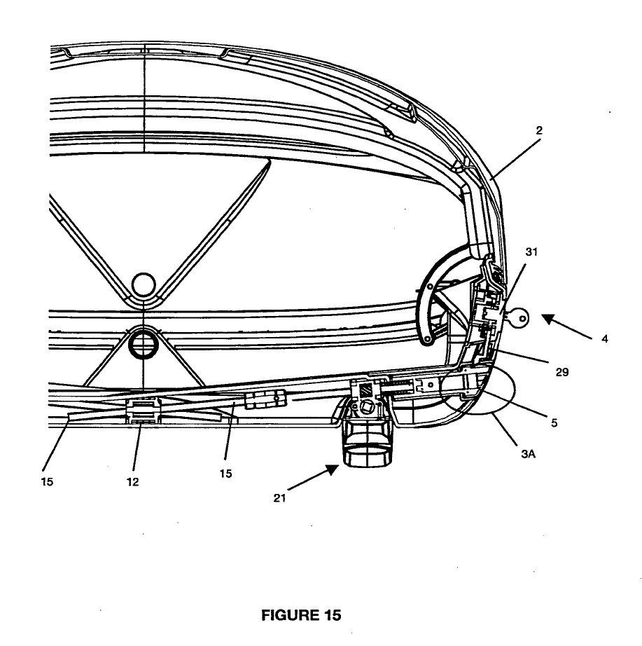

FIG. 15 shows a cross section of the assembled roof box and clamping mechanism about a section line running through the lateral channel exposing the cross driveshaft 15, a right angle gearbox 21 and a transfer gearbox 12. The handle 5 can be seen at one side of the drawing linked to the cross driveshaft 15. As noted in earlier discussions, the cross driveshaft includes a stopper 13 to prevent the handle being pulled out too far along direction A. As shown in FIG. 15, the handle 5 is retained in place when not required via a locking plunger 29 within the locking mechanism 4. The locking plunger 29 engages the top of the handle retaining this with a receptacle housing in the roof box 1 base section 3. The locking plunger 29 is biased to a locked position where the locking plunger 29 engages the handle 5. When the key 31 is turned in the lock, the locking plunger is urged against the bias (being a spring) thereby releasing the handle 5 and allowing the handle 5 to be pulled from the roof box 1 base section 3 receptacle housing 3A. The user can then pull the handle 5 out along direction A and rotate the handle to clamp or unclamp the box 1 to the roof racks 8. When the handle 5 is no longer required, the handle 5 may be pushed back into the roof box 1 base section 3 receptacle housing 3A and on doing so, the bias action of the locking plunger 29 causes the locking plunger 29 to reengage the handle 5 retaining the handle 5 back in the closed position.

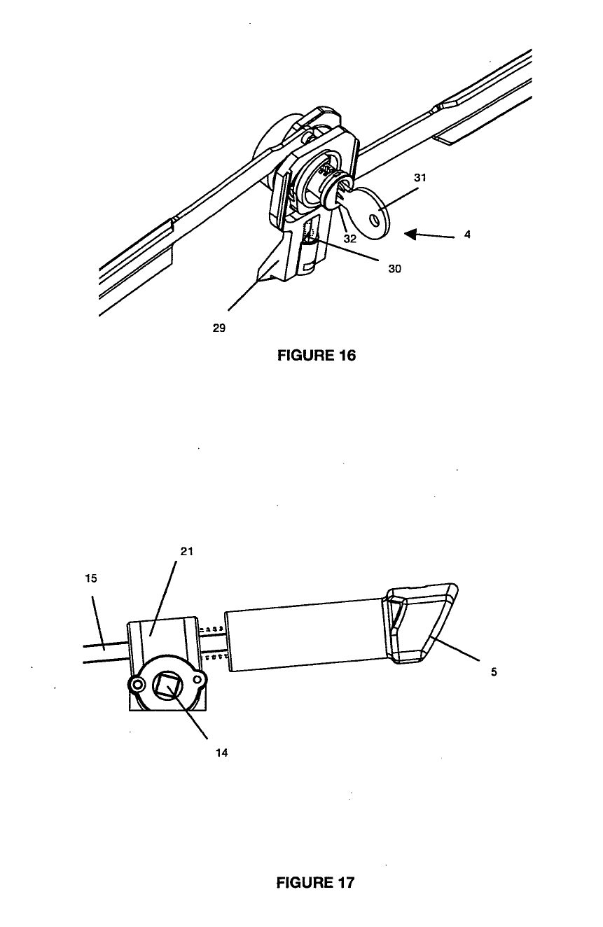

FIG. 16 shows a detail view of the locking assembly 4. The locking assembly 4 includes the lock chamber facing 32 viewable from the exterior of the roof box 1. Rotation of the key 31 in the lock chamber 32 to the left by 90 degrees in the embodiment shown in FIG. 16 disengages the locking plunger 29 allowing the handle 5 to be released. In the embodiment shown in FIG. 16, the key 31 may instead be rotated to the right to open the roof box 1 top section 2. It should be appreciated that other arrangements may be possible for key 31 rotation and actuation without departing from the scope of the invention.

FIG. 17 shows a detail elevation view of the handle 5 and right angle gearbox 21. The handle 5 is linked to the right angle gearbox 21 via the cross driveshaft 15. The right angle gearbox 21 includes a mating worm and ratchet transferring rotation movement of the cross driveshaft 15 to rotation of the longitudinal driveshaft 14.

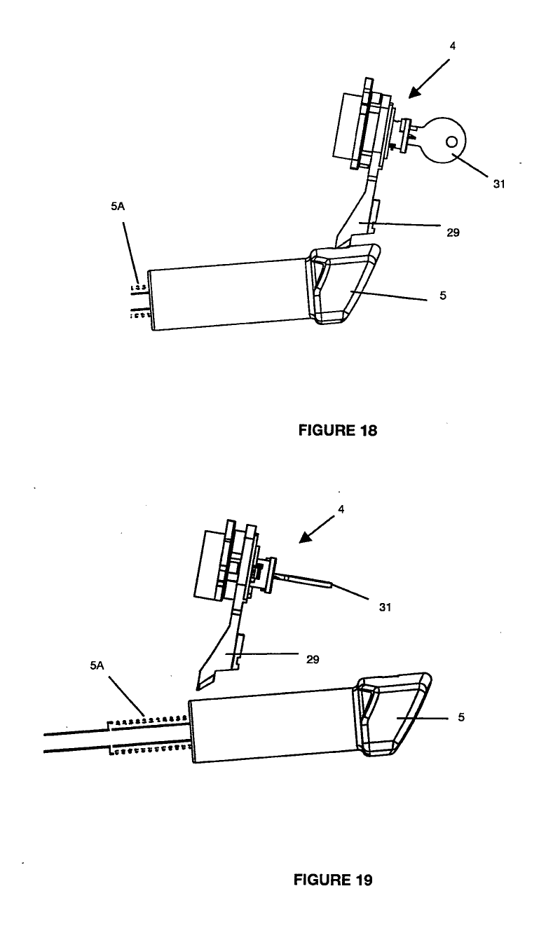

FIGS. 18 and 19 illustrate two views of the handle 5 in a retracted and unused first position and a second expended and actuated position. As noted above, the locking plunger 29 retains the handle 5 in a closed position and, when the plunger 29 is released from the handle 5 via the locking assembly 4, the handle 5 extends forwards. Extension forwards may be urged by use of a biasing means such as a spring 5A that biases the handle 5 to an open or extended position. The user may then easily grip the handle 5 once released and if need be, engage the handle 5 to the cross driveshaft 15 if this has not already been engaged via the bias action.

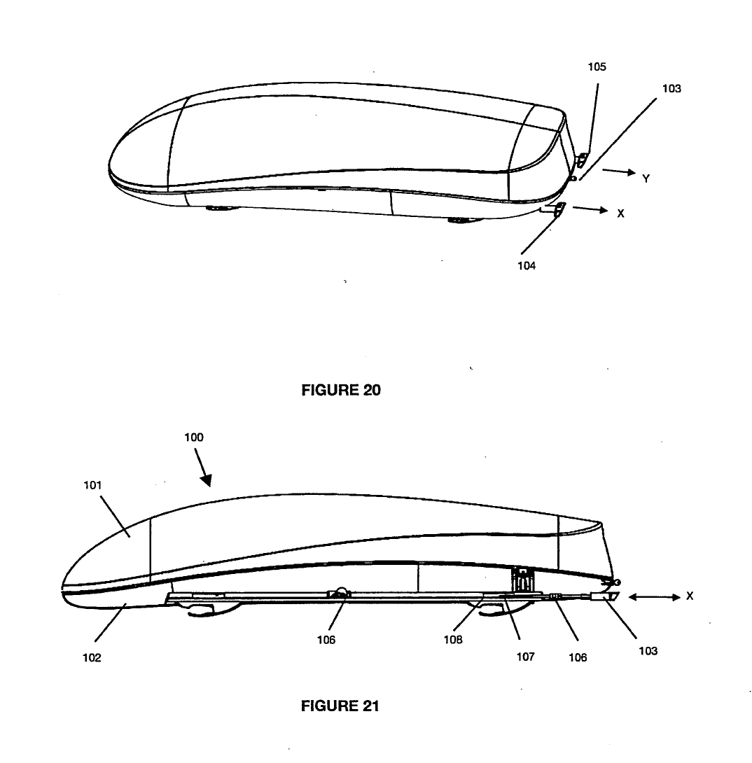

FIG. 20 shows an alternative clamping mechanism arrangement. In this embodiment, the roof box 100 includes a top section 101 and a base section 102. The roof box includes a lock assembly, the exterior facing of which is indicated by arrow 103. In this embodiment, the clamping mechanism utilises two handles 104 and 105 located at the rear of the roof box 100 base section 103. Rotation of a key (not shown) in the lock releases the handles 104, 105 via linkages 106 and 107. The handles 104, 105 may then be pulled out along direction X for handle 104 and direction Y for handle 105. As may be appreciated, in this embodiment use of a lateral channel 10, right angle gearbox 11 and transfer gearbox 12 may be avoided therefore simplifying the mechanics. However, preference is to be able to use only one handle in order to clamp and unclamp the roof box. In the rear handle embodiment, one further for this double handle embodiment is to link the action of one handle to all four clamping assemblies in a similar manner to that of the first embodiment described above e.g. using at least one right angle gearbox. Avoiding rotation of both handles when only one is turned may be accomplished by use of an engagement/disengagement mechanism in or proximate to the handle(s) thereby avoiding the need to pull out both rear handles when clamping or unclamping.

As should be appreciated form the above, handle 5, 104, 105 placement may be varied without departing from the scope of the invention.

More detail about the clamping mechanism of this alternative embodiment may be viewed in FIG. 21. As shown in FIG. 21, the handle 103 connects to two clamp assemblies 108 and related clutch assemblies 107 via a driveshaft 106. In the embodiment shown no gearboxes are used and rotation of the handle 103 only actuates opening and closing of the two longitudinally orientated clamping assemblies 108. As noted above, a gearbox arrangement (not shown) may also be used to link the two handles 103 and 104 to avoid the need to rotate both handles 103, 104 in order to clamp or unclamp the roof box 1, 100 and a roof rack 8.

As should be appreciated from the above, the clamping mechanism provided for the roof box 1, 100 is simple to use and allows the roof box 1, 100 to be easily fixed to the vehicle roof racks 8 via only one actuating point or optionally via two actuating points. There is no need for the user to open or close multiple latches or attachment points in order to clamp the box. Further, the clamping mechanism may be actuated without having to open the roof box 1, 100 itself meaning that, for example, a full roof box 1, 100 may be removed from the vehicle and then carried to a suitable location before opening unlike many existing designs where the box must be opened first, contents moved around to access the clamps and then detached, often from a difficult position as the box may be hard to reach when mounted on a vehicle roof. A further advantage is that the clamping mechanism is discrete and housed within the roof box 1, 100. Further, the actuating handle 5 or handles 103, 104 for the clamping mechanism may be placed on sides of the roof box 1, 100 allowing roof box 1, 100 detachment or attachment from either, side of a vehicle. A further aesthetic advantage of the clamping mechanism is that it produces a positive ‘click’ or ratchet action when the appropriate clamp tightness on the bar is reached thereby preventing over-tightening.

Aspects of the present invention have been described by way of example only and it should be appreciated that modifications and additions may be made thereto without departing from the scope of the claims herein.

1-28. (canceled)

29. A roof box including a base section mountable to at least one roof rack and a top section movable relative to the base section for opening and closing the roof box wherein the roof box has a clamping mechanism for clamping the roof box to the at least one roof rack including:
a. at least one torque input device accessed from the exterior of the roof box;
b. at least one clamp;
c. at least one force transfer means linking the torque input device(s) to the clamp(s);
d. at least one load equalising device; and
wherein the torque input device or devices are mounted along one or both longitudinal sides of the roof box and communicate with the clamp or clamps via the at least one force transfer means.

30. The roof box as claimed in claim 29 wherein the torque input device is a handle or motor.

31. The roof box as claimed in claim 29 wherein the force transfer means is a drive shaft, chain or belt.

32. The roof box as claimed in claim 29 wherein the load equalising device is a clutch or differential.

33. The roof box as claimed in claim 29 wherein the torque input device or devices communicate with the clamp or clamps via a cross driveshaft linked to a right angle gearbox and a longitudinal driveshaft on which the clamp or clamps are mounted.

34. The roof box as claimed in claim 29 wherein the roof box has two torque input devices located on each longitudinal side of the roof box allowing actuation of the clamping mechanism from either side of the roof box.

35. The roof box as claimed in claim 34 wherein the two torque input devices are linked to two separate force transfer means being cross driveshafts that are linked via a transfer gearbox.

36. The roof box as claimed in claim 35 wherein the transfer gearbox communicates actuation of at least one torque input device to the clamp or clamps so that the clamping mechanism is operated via one torque input device.

37. The roof box as claimed in claim 29 wherein the torque input device or devices are a handle or handles that are actuated by rotation of the handle or handles.

38. The roof box as claimed in claim 29 wherein the torque input device or devices are nested within at least one housing receptacle on the roof box base section.

39. The roof box as claimed in claim 29 wherein the torque input device or devices are moved from a neutral or non-engaged position for storage to an engaged or actuating position by movement in the horizontal plane.

40. The roof box as claimed in claim 29 wherein a user engages the torque input device or devices by pulling the device away from the roof box side wall or walls.

41. The roof box as claimed in claim 29 wherein the torque input device or devices are locked when not in use via a locking assembly.

42. The roof box as claimed in claim 41 wherein the locking assembly includes a locking plunger biased to engage a cam surface on the torque input device or devices and, unless unlocked, the biased plunger prevents the torque input device or devices from being pulled away from the roof box and actuated.

43. The roof box as claimed in claim 29 wherein the clamp or clamps include a clamp jaw, a clamp body and a jaw movement assembly that transfers torque input device actuation to clamp jaw movement relative to the clamp body.

44. The roof box as claimed in claim 43 wherein the clamp jaw pivots about an axis linking one end of the clamp jaw and the clamp body.

45. The roof box as claimed in claim 43 wherein the jaw movement assembly includes a clamp slider driven along the driveshaft axis and which communicates rotational movement of the clamp jaw via at least one pivotal link.

46. The roof box as claimed in claim 43 wherein the jaw movement assembly includes a worm driven along the driveshaft axis and which communicates rotational movement of the clamp jaw via a ratchet arrangement on the clamp jaw that engages the worm.

47. The roof box as claimed in claim 29 wherein the load equalising device or devices torque limit the torque input device or devices.

48. The roof box as claimed in claim 29 wherein the load equalising device is a clutch assembly that includes a drive spindle and a drive spline that drive a driven spline and wherein, when maximal torque is reached by rotation of the drive spindle and drive spline, the driven spline is forced to disengage from the drive spline via angled facings on the drive spline and wherein, when direction of rotation is reversed, the driven spline reengages the drive spline.

49. The roof box as claimed in claim 29 wherein the clamping mechanism is housed within the base section of the roof box and the only externally viewed features of the clamping mechanism beyond the roof box exterior is the clamp or clamps and the handle or handles.

50. The roof box as claimed in claim 49 wherein a lock assembly is used that is also visible on the beyond the roof box exterior.

51. The roof box as claimed in claim 29 wherein the base section of the roof box includes at least one channel which houses the clamping mechanism.

52. A method of securing a roof box to at least one roof rack by use of a clamping mechanism that engages a roof rack crossbar on a vehicle including: at least one torque input device accessed from the exterior of the roof box; at least one clamp; at least one force transfer means linking the torque input device(s) to the clamp(s); and at least one load equalising device; and wherein a user secures the roof box by the step of:
the user actuates the torque input device or devices on the roof box exterior thereby causing the force transfer means to tighten the clamp or clamps against one or more roof rack crossbars and the tightness of the clamp or clamps is governed by the load equalising device or devices.

53. A clamp for linking a roof rack accessory item to a roof rack cross bar wherein the clamp can be used on a variety of crossbar shapes wherein the clamp comprises:
(a) a fixed portion integral to the accessory item; and
(b) an opposing pivoting claw with a double concave crossbar facing surface;
wherein the cross sectional profile of the fixed portion and claw when in a crossbar holding position abuts and releasably retains the accessory item against the crossbar, producing three resolved applied forces on the crossbar to contain the crossbar within the clamp and,
wherein the fixed portion has a cross sectional shape comprising a notch between two raised projections wherein the transition between the notch and one or both of the raised projections is a smooth arcuate angle.

54. The clamp as claimed in any one of claim 53 wherein a second concave region of the double concave shape of the claw is located towards the non-pivot point distil end of the claw.

55. The clamp as claimed in claim 54 wherein the second concave region is a smoothed path suitable to receive a tear drop cross section shaped crossbar.

56. A roof box including a base section mountable to at least one roof rack and a top section movable relative to the base section for opening and closing the roof box wherein the roof box has a clamping mechanism for clamping the roof box to a roof rack including:
at least one torque input device;
at least one clamp;
at least one force transfer means linking the torque input device(s) to the clamp(s);
at least one load equalising device; and
wherein the torque input device or devices are accessed from the exterior of the roof box.
